(19) United States
(12) Patent Application Publication
(10) Pub. No.: US 2023/0316438 A1
(43) Pub. Date: Oct. 5, 2023

(54) BOUNDARY-BASED PROPERTY IDENTIFIERS

(71) Applicant: CoreLogic Solutions, LLC, Irvine, CA (US)

(72) Inventors: Frankie Famighetti, Pembroke Pines, FL (US); Anand Singh, Tustin, CA (US); Ashish Jain, Boulder, CO (US); Sachin Rajpal, Southlake, TX (US)

(21) Appl. No.: 18/127,592

(22) Filed: Mar. 28, 2023

Related U.S. Application Data
(60) Provisional application No. 63/325,497, filed on Mar. 30, 2022.
(60) Provisional application No. 63/381,701, filed on Oct. 31, 2022.

(51) Int. Cl. G06Q 50/16

(52) U.S. Cl. CPC G06Q 50/16

(57) ABSTRACT

A system that can generate unique identifiers for individual real estate parcels and/or individual structure(s) located on individual real estate parcels using geometric land and/or building information is described. For example, the system can obtain geographical coordinate information and/or topological information that defines a two-dimensional or three-dimensional boundary of a parcel. The system can then determine and assign a unique identifier to the parcel, where the unique identifier is based on the two-dimensional or three-dimensional boundary. As another example, the system can obtain geographical coordinate information and/or structure architectural plans that define a two-dimensional or three-dimensional boundary of a structure. The system can then determine and assign a unique identifier to the structure, where the unique identifier is based on the two-dimensional or three-dimensional boundary of the structure.

### CROSS-REFERENCE TO RELATED APPLICATIONS

This application claims priority under 35 U.S.C. § 119(e) to U.S. Provisional Patent Application No. 63/325,497, entitled “GEOSPATIAL CLIP” and filed on Mar. 30, 2022, and to U.S. Provisional Patent Application No. 63/381,701, entitled “GEOSPATIAL CLIP” and filed on Oct. 31, 2022, the entire disclosures of which are hereby incorporated by reference herein.

### BACKGROUND

Data corresponding to real estate parcels (also referred to herein as real estate properties) may include various attributes, including lot size, number of bedrooms, number of bathrooms, street address, and/or the like. In some cases, a particular parcel may change over time. For example, the parcel may be split into two or more sub-parcels, the parcel may be merged with another parcel, the zoning of the parcel may change (e.g., from residential to commercial, from industrial to commercial, etc.), a street address of the parcel may change, and/or the like. A parcel that changes may have new attributes associated with the change.

### SUMMARY

The systems, methods, and devices described herein each have several aspects, no single one of which is solely responsible for its desirable attributes. Without limiting the scope of this disclosure, several non-limiting features will now be discussed briefly.

One aspect of the disclosure provides a system for retrieving property information. The system comprises memory that stores computer-executable instructions. The system further comprises a processor in communication with the memory, where the computer-executable instructions, when executed by the processor, cause the processor to: obtain a query for information related to a first input; determine that the first input corresponds to a first identifier, where the first identifier is generated based at least in part on a physical boundary of one of a parcel, a structure, or a unit corresponding to the first input; retrieve property data linked to the first identifier; and cause a user device to display a user interface that depicts the retrieved property data.

The system of the preceding paragraph can include any sub-combination of the following features: where the computer-executable instructions, when executed, further cause the processor to: determine that a second identifier is linked to the first identifier; retrieve second property data linked to the second identifier, and cause the user device to display the user interface that depicts the retrieved property data and the retrieved second property data; where the first identifier comprises a parcel unique identifier corresponding to a parcel, and where the second identifier comprises a structure unique identifier corresponding to a structure that resides on the parcel; where the first identifier comprises a structure unit unique identifier corresponding to a unit in a structure on a parcel, and where the second identifier comprises a structure unique identifier corresponding to the structure; where the computer-executable instructions, when executed, further cause the processor to: determine that a third identifier is linked to one of the first identifier or the second identifier, retrieve second property data linked to the third identifier, and cause the user device to display the user interface that depicts the retrieved property data, the retrieved second property data, and the retrieved third property data; where the first identifier comprises a parcel unique identifier corresponding to a parcel and the second identifier comprises a structure unique identifier corresponding to a structure that resides on the parcel, and where the third identifier comprises a structure unit unique identifier corresponding to a unit within the structure that resides on the parcel; where the first identifier comprises a parcel unique identifier corresponding to a parcel and the second identifier comprises a first structure unique identifier corresponding to a first structure that resides on the parcel, and where the third identifier comprises a second structure unique identifier corresponding to a second structure that resides on the parcel; where the first identifier comprises a structure unique identifier corresponding to a structure that resides on a parcel and the second identifier comprises a first structure unit unique identifier corresponding to a first unit within the structure that resides on the parcel, and where the third identifier comprises a second structure unit unique identifier corresponding to a second unit within the structure that resides on the parcel; where the first identifier comprises a structure unit unique identifier corresponding to a unit in a structure on a parcel and the second identifier comprises a structure unique identifier corresponding to the structure on the parcel, and where the third identifier comprises a parcel unique identifier corresponding to the parcel; where the first identifier comprises a parcel unique identifier corresponding to a parcel, and where the computer-executable instructions, when executed, further cause the processor to: determine that a current boundary of the parcel is different than a previous boundary of the parcel by a threshold value, determine that the parcel has one of split into a first sub-parcel and a second sub-parcel or merged with a second parcel to form a third parcel based on the determination that the current boundary is different than the previous boundary by the threshold value, generate a second identifier for the parcel based on the current boundary, and link the first identifier with the second identifier; and where the first input comprises one of an address, a name of an owner, a geocode, geographic coordinates, an assessor parcel number, or a second identifier.

Another aspect of the disclosure provides a computer-implemented method for retrieving property information. The computer-implemented method comprises: obtaining a query for information related to a first input; determining that the first input corresponds to a first identifier, where the first identifier is generated based at least in part on a physical boundary of one of a parcel, a structure, or a unit corresponding to the first input; retrieving property data linked to the first identifier; and causing a user device to display a user interface that depicts the retrieved property data.

The computer-implemented method of the preceding paragraph can include any sub-combination of the following features: where the computer-implemented method further comprises: determining that a second identifier is linked to the first identifier, retrieving second property data linked to the second identifier, and causing the user device to display the user interface that depicts the retrieved property data and the retrieved second property data; where the first identifier comprises a parcel unique identifier corresponding to a parcel, and where the second identifier comprises a structure unique identifier corresponding to a structure that resides on the parcel; where the computer-implemented method further comprises: determining that a third identifier is linked to one of the first identifier or the second identifier, retrieving second property data linked to the third identifier, and causing the user device to display the user interface that depicts the retrieved property data, the retrieved second property data, and the retrieved third property data; where the first identifier comprises a structure unit unique identifier corresponding to a unit in a structure on a parcel and the second identifier comprises a structure unique identifier corresponding to the structure on the parcel, and where the third identifier comprises a parcel unique identifier corresponding to the parcel; and where the first identifier comprises a parcel unique identifier corresponding to a parcel, and where the computer-implemented method further comprises: determining that a current boundary of the parcel is different than a previous boundary of the parcel by a threshold value, determining that the parcel has one of split into a first sub-parcel and a second sub-parcel or merged with a second parcel to form a third parcel based on the determination that the current boundary is different than the previous boundary by the threshold value, generating a second identifier for the parcel based on the current boundary, and linking the first identifier with the second identifier.

Another aspect of the disclosure provides a non-transitory, computer-readable medium comprising computer-executable instructions for retrieving property information, where the computer-executable instructions, when executed by a computer system, cause the computer system to: obtain a query for information related to a first input; determine that the first input corresponds to a first identifier, where the first identifier is generated based at least in part on a physical boundary of one of a parcel, a structure, or a unit corresponding to the first input; retrieve property data linked to the first identifier; and cause a user device to display a user interface that depicts the retrieved property data.

Another aspect of the disclosure provides a computer-implemented method for retrieving property information. The computer-implemented method comprises: obtaining a query for information related to a first address; identifying property data linked to the first address with an identifier, where the identifier is generated based at least in part on a physical boundary of a parcel corresponding to the first address; retrieving the property data; and causing a user device to display a user interface that depicts the retrieved property data.

The computer-implemented method of the preceding paragraph can include any sub-combination of the following features: where the computer-implemented method further comprises generating the identifier based at least in part on the physical boundary of the parcel and a value that identifies a geographic cell derived based on a spherical projection; where the value that identifies the geographical cell derived based on the spherical projection comprises a value that corresponds to a geographic area corresponding to a location on a surface of Earth that includes individual points mapped to a mathematical sphere; where generating the identifier further comprises generating the identifier based at least in part on the physical boundary of the parcel, the value that identifies the geographic cell derived based on the spherical projection, and a sequence number; where the value comprises a multi-bit value, and where a first bit of the value that is a higher order than a second bit of the value represents a larger geographic area than a geographic area represented by the second bit; where the user interface further depicts the identifier; where the property data comprises at least one of an owner of a parcel corresponding to the first address, a property name, or a parcel name; and where the physical boundary comprises one of a two-dimensional or three-dimensional boundary.

Another aspect of the disclosure provides a computer-implemented method for retrieving property information. The computer-implemented method comprises: obtaining a query for information related to a first address; identifying property data linked to the first address using an identifier; and causing a user device to display a user interface that depicts the identified property data.

The computer-implemented method of the preceding paragraph can include any sub-combination of the following features: where the computer-implemented method further comprises generating the identifier based at least in part on a physical boundary of a structure at the first address and a value that identifies a geographic cell derived based on a spherical projection; where the value that identifies the geographical cell derived based on the spherical projection comprises a value that corresponds to a geographic area corresponding to a location on a surface of Earth that includes individual points mapped to a mathematical sphere; where generating the identifier further comprises generating the identifier based at least in part on the physical boundary of the structure, the value that identifies the geographic cell derived based on the spherical projection, and a sequence number; and where the first input comprises one of an address, a name of an owner, a geocode, geographic coordinates, an assessor parcel number, or a second identifier.

### BRIEF DESCRIPTION OF DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram of an illustrative operating environment in which a geospatial property identifier system generates unique identifiers for individual blocks, parcels, and/or structures.

FIG. 2 is a flow diagram illustrating the operations performed by the components of the operating environment of FIG. 1 to generate a unique identifier.

FIG. 3 is a flow diagram illustrating the operations performed by the components of the operating environment of FIG. 1 to generate a unique identifier.

FIG. 4 is a flow diagram illustrating the operations performed by the components of the operating environment of FIG. 1 to generate a unique identifier.

FIG. 5 is a flow diagram illustrating the operations performed by the components of the operating environment of FIG. 1 to generate a unique identifier.

FIG. 6 is a flow diagram illustrating the operations performed by the components of the operating environment of FIG. 1 to generate a persistent identifier.

FIG. 7 is a flow diagram depicting an example, property information retrieval routine illustratively implemented by a geospatial property identifier system, according to one embodiment.

FIG. 8 is another flow diagram depicting an example, property information retrieval routine illustratively implemented by a geospatial property identifier system, according to one embodiment.

### DETAILED DESCRIPTION OF SPECIFIC EMBODIMENTS

As described above, a parcel may change over time. In situations in which a parcel changes, the changed parcel may include an updated or new set of attributes (e.g., where attributes can include lot size, number of bedrooms, number of bathrooms, square footage, street address, neighborhood, an identification of the homeowner's association, year built, roof material, siding material, window type, parcel owner, etc.). For example, a parcel may originally include a first street address. After the parcel is split into two or more sub-parcels, the first sub-parcel may have a second street address that is different than the first street address and the second sub-parcel may have a third street address that is different than the first and second street addresses. In addition, the size of each sub-parcel may be smaller than the size of the original parcel.

A data store or multiple data stores may store the attributes for various parcels. When the attributes of a parcel are updated, the data store(s) may also be updated to reflect the changes. However, in situations in which a parcel is changed, a new entry may be created in the data store(s) for the attributes of the newly formed parcel (e.g., if an original parcel is split, a new entry may be created for one of the sub-parcels; if an original parcel is merged with another parcel, a new entry may be created for the merged parcel; etc.). Conventional systems do not provide any mechanism for linking attributes of an original parcel with attributes of a changed parcel. As a result, it may be difficult for users to identify how a parcel has changed over time. In fact, in some situations, conventional systems may remove data from the data store(s) that could otherwise be used to show the history of change of a parcel over time. For example, while a parcel may have changed, some attributes of the original parcel and the changed parcel may remain constant. Conventional systems may use deduplication operations to periodically pare duplicate records stored in the data store(s) to conserve memory usage. Applying these deduplication operations may sometimes result in a conventional system determining that the record for an original parcel is a duplicate of the record for a changed parcel given that the original parcel record includes attributes in common with the record corresponding to the changed parcel removing the record for the original parcel as a result.

Furthermore, parcels are often categorized as a whole for the purpose of estimating the impacts of hazards. For example, a parcel may be categorized as falling in a hazard zone and being subject to a particular type of hazard (e.g., flood, hail, hurricane, tornado, wind, earthquake, wildfire, mudslide, etc.) at a particular risk level. The hazard zone categorization may be useful in assessing potential damage to a structure on the parcel following a hazard, predicting what damage may occur to a structure on the parcel in the future, and/or protecting structures on the parcel from future damage. However, some parcels include more than one structure. Conventional systems have no mechanism for differentiating one structure on a parcel from another structure on the parcel because it is often unclear from the parcel or property data if there are multiple structures on a parcel and, if so, whether the property data is for the structure considered the primary structure or for one of the secondary structures. This can be problematic if, for example, one of the structures on the parcel should fall into one hazard zone and another one of the structures on the parcel should fall into a different hazard zone. In a situation in which multiple hazard zones overlap a parcel, the hazard zone for one structure may be used to categorize the entire parcel and all of the structures residing therein. As a result, one of the structures on the parcel may be miscategorized as falling into a particular type of hazard zone, which can lead to otherwise preventable damage to the structure, preventable loss of life from an unexpected hazard (e.g., because the hazard that did occur is different than the hazard of the hazard zone to which the structure is categorized), and/or the like.

Similarly, because the property data stored in the data store(s) may correspond to one structure on a parcel, a situation may occur in which multiple records are stored in the data store for a particular parcel with different attributes (e.g., where one record corresponds to one structure on the parcel and another record corresponds to another structure on the parcel). Conventional systems may be unable to determine whether the records are duplicates, whether one data record has incorrect information and should be deleted, whether the records have conflicting information, or whether some or all of the records are valid and correspond to different structures on the parcel. This lack of clarity can lead to incorrect assessments of certain parcels, which can lead to otherwise preventable structure damage, preventable loss of life from a hazard or unidentified building code violation, and/or the like.

Accordingly, the present disclosure generally describes a system that can generate unique identifiers for individual real estate parcels and/or individual structure(s) located on individual real estate parcels using geometric land and/or building information. For example, the system can obtain geographical coordinate information and/or topological information that defines a two-dimensional or three-dimensional boundary of a parcel. The system can then determine and assign a unique identifier to the parcel, where the unique identifier is based on the two-dimensional or three-dimensional boundary. As another example, the system can obtain geographical coordinate information and/or structure architectural plans that define a two-dimensional or three-dimensional boundary of a structure. The system can then determine and assign a unique identifier to the structure, where the unique identifier is based on the two-dimensional or three-dimensional boundary of the structure. The system can repeat these operations to determine unique identifiers for a plurality of parcels and/or for a plurality of structures (where one or more structures may be present on a particular parcel).

In fact, by assigning unique identifiers to structures on a parcel, the system can also identify the structure that would be considered the primary structure and the structure(s) that would be considered secondary structure(s). Generally, property data associated with a parcel includes data corresponding to one of the structures on the parcel. However, it is often unclear from the property data if there are multiple structures on a parcel and, if so, whether the property data is for the structure considered the primary structure or for one of the secondary structures. Thus, if a user requests property data for the parcel, the system can then generate and produce search results that include different property data for each individual structure on the parcel (rather than property data for the parcel as a whole without any indication of to which structure the property data corresponds). The system can also then assign individual structures to different hazard zones, if appropriate. This can allow users to take appropriate actions to prevent or mitigate structural damage and/or prevent or reduce the chances of loss life from a hazard.

In some instances, the system can generate a unique identifier for an individual real estate block (e.g., a set of real estate parcels that share a characteristic, such as location, neighborhood, subdivision, etc.), an individual real estate parcel, and/or an individual structure located on an individual real estate parcel that can be based on (1) geometric land and/or building information, (2) a value that (uniquely) identifies a geographic cell (e.g., a quadrilateral bounded by four geodesics) derived based on a spherical projection (e.g., a value that corresponds to a geographic area corresponding to a location on the surface of Earth that includes individual points mapped to a mathematical sphere), and/or (3) a sequence number. The unique identifier based on geometric land and/or building information, a geographic cell value, and/or a sequence number may also be referred to herein as a persistent identifier.

As described herein, the system can obtain geographical coordinate information and/or topological information that defines a two-dimensional or three-dimensional physical boundary of a parcel. The system can then determine and assign a first intermediate identifier to the block or parcel, where the first intermediate identifier is based on the two-dimensional or three-dimensional boundary. As another example, the system can obtain geographical coordinate information and/or structure architectural plans that define a two-dimensional or three-dimensional boundary of a structure. The system can then determine and assign a first intermediate identifier to the structure, where the first intermediate identifier is based on the two-dimensional or three-dimensional boundary of the structure. The system can repeat these operations to determine first intermediate identifiers for a plurality of blocks, for a plurality of parcels, and/or for a plurality of structures (where one or more structures may be present on a particular parcel). In some embodiments, the two-dimensional or three-dimensional boundary of the structure (or block or parcel) is represented by an exact or nearly exact boundary (e.g., within a threshold percentage of an exact boundary, such as within 1%, 0.1%, 0.001%, etc.) of the structure (e.g., as indicated in structure architectural plans). In other embodiments, the two-dimensional or three-dimensional boundary of the structure (or block or parcel) is represented by a rough boundary of the structure formed by combining one or more basic geometric shapes, such as circles, ovals, rectangles, squares, triangles, hexagons, cubes, cuboids, cones, cylinders, spheres, etc. (e.g., regular shapes that are symmetric rather than irregular shapes that may be freeform shapes and/or asymmetric). Using a rough boundary of a structure (or block or parcel) rather than an exact or nearly exact boundary of a structure (or block or parcel) may allow the system to differentiate between block, parcel, and/or structure splits and situations in which a slight modification is made to a block, parcel, and/or structure that otherwise may not warrant the generation of a new unique identifier for the block, parcel, and/or structure. For example, a slightly modified block, parcel, and/or structure may have the same rough boundary as the unmodified block, parcel, and/or structure, but may not have the same exact or nearly exact boundary as the unmodified block, parcel, and/or structure.

The system can further generate a second intermediate identifier based on a geographic cell within which the block, parcel, and/or structure is located. For example, the value that identifies a geographic cell may be referred to herein as a geographic cell identifier. The geographic cell identifier may be a 64-bit value, where higher order bits represent a larger geographic area in which the geographic cell is located and lower order bits represent a smaller geographic area in which the geographic cell is located (e.g., each higher bit may represent a higher region, ranging from sub-millimeter level to sub-meter level to meter level to parcel level to block level to city level to state level to country level to continent level to hemisphere level and so on, as the bits are traversed from lower order bits to higher order bits). The system may set the second intermediate identifier to be equal to the geographic cell identifier of the geographic cell in which the block, parcel, and/or structure is located.

The system can further generate a third intermediate identifier that may also be referred to herein as a sequence number. The sequence can be a value that distinguishes between different parcels that are located in the same geographic location and that have the same structural boundary or geometry. For example, individual condominiums in a high-rise condominium complex may share the same geographic location and structural boundary or geometry. The system may assign each individual parcel (e.g., each individual condominium) that shares the same geographic location and structural boundary or geometry a different sequence number. If, for example, the block, parcel, and/or structure does not share a geographic location or structural boundary or geometry with another block, parcel, and/or structure, then the system may assign the block, parcel, and/or structure a sequence number of 1 or 0.

The system can generate a unique identifier for a block, parcel, and/or structure by combining some or all of the first intermediate identifier, the second intermediate identifier, and/or the third intermediate identifier of the block, parcel, and/or structure. For example, the system can concatenate the first intermediate identifier, the second intermediate identifier, and/or the third intermediate identifier in any order, can apply a mathematical function to some or all of the identifiers together, can include some or all of the identifiers as separate elements in a vector that collectively represents the unique identifier for the block, parcel, and/or structure, and/or the like.

In some instances, the system can detect situations in which a block, parcel, and/or structure is split. For example, the system can periodically determine block, parcel, and/or structure boundaries for one or more blocks, parcels, and/or structures. If the system determines that the current boundary for a block, parcel, and/or structure is different than a previous boundary for the block, parcel, and/or structure by a threshold value or percentage (e.g., 50%, 55%, 60%, etc.), this may indicate that the block, parcel, and/or structure has been split. In response, the system may generate a new unique identifier for the block, parcel, and/or structure and/or for the new blocks, parcels, and/or structures created by the split in a manner as described above. In some cases, the new unique identifier may be formed by the system by creating a new third intermediate identifier (leaving the previous first and second identifiers the same), such that the sequence number may differentiate one portion of a split block, parcel, and/or structure from another portion of the split block, parcel, and/or structure.

The unique identifiers generated by the system described herein can address the technical deficiencies of conventional systems described above. For example, the unique identifiers may allow the system described herein to link a unique identifier corresponding to an original parcel with a unique identifier corresponding to a changed parcel. As a result, the system described herein can distinguish between property data records that are duplicates and property data records that correspond to changes in a parcel such that the system can apply deduplication operations without the risk of data corresponding to old parcel being inadvertently deleted. Because the system described herein can also assign unique identifiers to individual structures on a parcel, the system described herein can assign different hazard zones to different structures on the same parcel, if appropriate, and can distinguish between property data records that are invalid (e.g., duplicates, have conflicting information, have the wrong information, etc.) and those that are valid. As a result, the system described herein can produce outputs that help users better protect and prevent damage to structures, loss of life, and/or the like.

The system described herein can further generate unique identifiers for some or all of the units located within a structure on a parcel. For example, a structure may include one unit (which is the structure itself) or multiple units, where each unit may represent a different business, a different residential space (e.g., condo unit, apartment unit, etc.), and/or the like, and where each unit may be reside within a structure in the same horizontal dimension (e.g., on the same floor) or in different horizontal dimensions (e.g., on different floors) and in the same vertical dimension (e.g., a unit is located directly above another unit) or in different vertical dimensions (e.g., a unit is located on a different floor than another unit and neither unit is directly above the other unit). The system described herein can use any of the techniques described herein to generate a unique identifier for a parcel or structure to also generate a unique identifier for one or more units located within a structure. Thus, the system described herein can generate, for one or more parcels, a unique identifier for the respective parcel (e.g., the physical land), a unique identifier for each structure located on the respective parcel, and/or a unique identifier for each unit located within each structure located on the respective parcel.

The system described herein may link the unique identifier for a parcel with unique identifier(s) for each structure located on the parcel and/or with unique identifier(s) for each unit located within each structure located on the parcel. The system described herein may further link the parcel identifier with property data corresponding to the parcel, the structure identifier(s) with property data corresponding to the respective structure, and/or the structure unit identifier(s) with property data corresponding to the respective unit. Thus, the property data for a parcel, the property data for structure(s) on the parcel, and/or the property data for unit(s) within structure(s) on the parcel may be linked using the parcel, structure, and/or structure unit unique identifiers.

Accordingly, a query to the system described herein for information related to a parcel may cause the system described herein to identify the unique identifier of the parcel, retrieve property data linked to the unique identifier (which can include property data corresponding to the parcel, property data corresponding to individual structures located on the parcel, and/or property data corresponding to individual structure units within structure(s) located on the parcel), and/or cause the retrieved property data to be displayed by a user device. Similarly, a query to the system described herein for information related to a first structure on a parcel may cause the system described herein to identify the unique identifier of the first structure, retrieve property data linked to the first structure unique identifier, optionally identify a unique identifier linked to the parcel on which the first structure resides, optionally retrieve property data linked to the parcel unique identifier, optionally identify structure unit unique identifier(s) linked to units within the first structure, optionally retrieve property data linked to the structure unit unique identifiers, and/or cause the retrieved property data to be displayed by a user device. Similarly, a query to the system described herein for information related to a first unit in a first structure on a parcel may cause the system described herein to identify the structure unit unique identifier of the first unit in the first structure on the parcel, retrieve property data linked to the structure unit unique identifier, optionally identify structure unit unique identifier(s) of other units in the first structure, optionally retrieve property data linked to the other structure unit unique identifier(s), optionally identify the structure identifier of the first structure within which the first unit is located, optionally retrieve property data linked to the identified structure identifier, optionally identify the parcel unique identifier of the parcel on which the first structure resides, optionally retrieve property data linked to the parcel unique identifier, and/or cause the retrieved property data to be displayed by a user device.

The foregoing aspects and many of the attendant advantages of this disclosure will become more readily appreciated as the same become better understood by reference to the following detailed description, when taken in conjunction with the accompanying drawings.

### Example Boundary-Based Property Identifier Environment

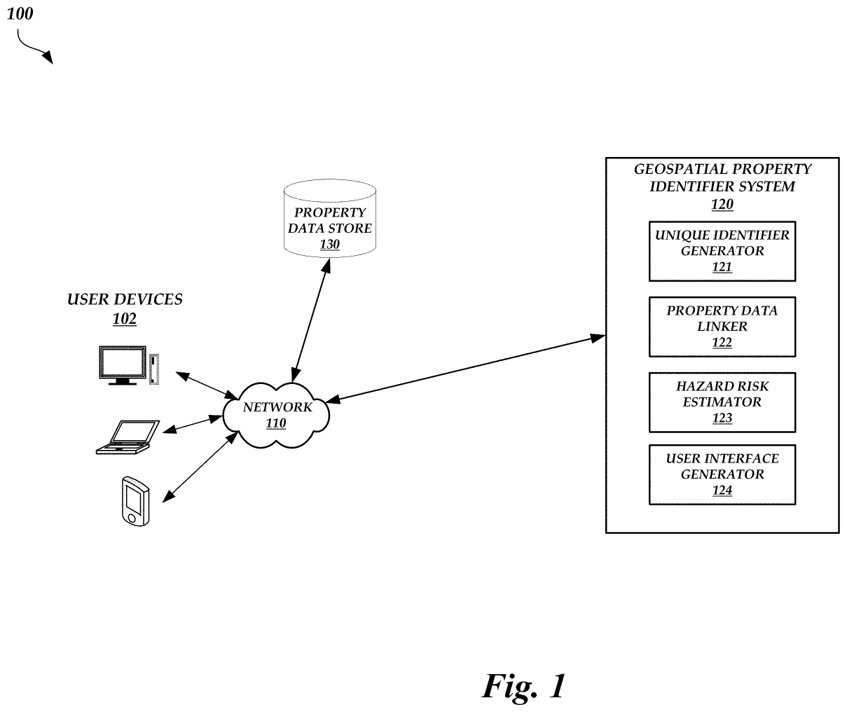

FIG. 1 is a block diagram of an illustrative operating environment 100 in which a geospatial property identifier system 120 generates unique identifiers for individual blocks, parcels, and/or structures. The operating environment 100 further includes one or more property data stores 130 with which the geospatial property identifier system 120 may communicate via network 110 to obtain parcel or property data for use in generating the unique identifiers. Furthermore, the operating environment 100 includes various user devices 102 that may communicate with the geospatial property identifier system 120 to request information on one or more parcels and/or one or more structures residing on a parcel.

The geospatial property identifier system 120 can be a computing system configured to generate unique identifiers for individual blocks, parcels, and/or structures, to link property data records, and/or to categorize individual structures of a parcel into one or more hazard zones. The geospatial property identifier system 120 may be a single computing device, or it may include multiple distinct computing devices, such as computer servers, logically or physically grouped together to collectively operate as a server system. The components of the geospatial property identifier system 120 can each be implemented in application-specific hardware (e.g., a server computing device with one or more ASICs) such that no software is necessary, or as a combination of hardware and software. In addition, the modules and components of the geospatial property identifier system 120 can be combined on one server computing device or separated individually or into groups on several server computing devices. In some embodiments, the geospatial property identifier system 120 may include additional or fewer components than illustrated in FIG. 1.

In some embodiments, the features and services provided by the geospatial property identifier system 120 may be implemented as web services consumable via the communication network 110. In further embodiments, the geospatial property identifier system 120 is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

The geospatial property identifier system 120 may include various modules, components, data stores, and/or the like to provide the unique identifier generation, linking, and hazard zone categorization functionality described herein. For example, the geospatial property identifier system 120 may include a unique identifier generator 121, a property data linker 122, a hazard risk estimator 123, and a user interface generator 124.

The unique identifier generator 121 can generate unique identifiers for blocks, parcels, and/or structures. The unique identifier generator 121 can generate unique identifiers when asynchronous of other operations. For example, the unique identifier generator 121 can generate unique identifiers in a background process while the geospatial property identifier system 120 performs other operations. The unique identifier generator 121 can generate unique identifiers for an existing group of blocks, parcels, and/or structures. As new blocks, parcels, and/or structures are created and corresponding data records are stored in the property data store 130, the unique identifier generator 121 can generate unique identifiers for the new blocks, parcels, and/or structures subject to the conditions described herein.

The unique identifier generator 121 can generate unique identifiers for individual real estate parcels, individual structure(s) located on individual real estate parcels, and/or individual unit(s) located within individual structure(s) located on individual real estate parcels using geometric land and/or building information. In particular, the unique identifier generator 121 can obtain geographical coordinate information and/or topological information that defines a two-dimensional or three-dimensional boundary of one or more parcels from the property data store 130. The unique identifier generator 121 can then determine and assign a unique identifier to each parcel, where the unique identifier is based on the two-dimensional or three-dimensional boundary of the respective parcel. As an illustrative example, the unique identifier generator 121 can convert the two-dimensional or three-dimensional boundary into a vector by including the position of some or all of the joints (e.g., a point connecting at least two edges) of the boundary, the starting position of some or all of the edges of the boundary, and/or the ending position of some or all of the edges of the boundary as an element in the vector. The position of a joint or edge may be a geographic coordinate and/or an altitude (e.g., in the case of a three-dimensional boundary). The unique identifier generator 121 can then process the vector (e.g., apply a hash algorithm to the vector, concatenate the values in each element of the vector, etc.) to form the unique identifier. The unique identifier generator 121 can repeat these operations to determine unique identifiers for a plurality of parcels.

To generate a unique identifier for structures on parcels, the unique identifier generator 121 can obtain geographical coordinate information and/or structure architectural plans that define a two-dimensional or three-dimensional boundary of one or more structures on one or more parcels (e.g., from the property data store 130, from an architectural data store (not shown), and/or the like). The unique identifier generator 121 can then determine and assign a unique identifier to each structure, where the unique identifier is based on the two-dimensional or three-dimensional boundary of the structure. As an illustrative example, the unique identifier generator 121 can convert the two-dimensional or three-dimensional boundary into a vector by including the position of some or all of the joints (e.g., a point connecting at least two edges) of the boundary, the starting position of some or all of the edges of the boundary, and/or the ending position of some or all of the edges of the boundary as an element in the vector. The position of a joint or a starting or ending edge may be a geographic coordinate and/or an altitude (e.g., in the case of a three-dimensional boundary). The unique identifier generator 121 can then process the vector (e.g., apply a hash algorithm to the vector, concatenate the values in each element of the vector, etc.) to form the unique identifier. The unique identifier generator 121 can repeat these operations to determine unique identifiers for a plurality of structures (where one or more structures may be present on a particular parcel).

For parcels that have multiple structures, the unique identifier generator 121 may use the structural architectural plans and/or geographic coordinates of the boundaries of the structures of the parcel to label a structure as being a primary structure or a secondary structure. For example, the unique identifier generator 121 can label the structure with the largest square footage as the primary structure and the other structures as secondary structures. The property data linker 122 may then link the unique identifier of each structure with the label assigned by the unique identifier generator 121 (e.g., primary structure or secondary structure).

To generate a unique identifier for units within structures on parcels, the unique identifier generator 121 can obtain, for one or more parcels and/or one or more structures residing therein, geographical coordinate information and/or structure architectural plans that define a two-dimensional or three-dimensional boundary of one or more units in the respective structure and/or on the respective parcel (e.g., from the property data store 130, from an architectural data store (not shown), and/or the like). The unique identifier generator 121 can then determine and assign a unique identifier to each unit, where the unique identifier is based on the two-dimensional or three-dimensional boundary of the unit. As an illustrative example, the unique identifier generator 121 can convert the two-dimensional or three-dimensional boundary into a vector by including the position of some or all of the joints (e.g., a point connecting at least two edges) of the boundary, the starting position of some or all of the edges of the boundary, and/or the ending position of some or all of the edges of the boundary as an element in the vector. The position of a joint or a starting or ending edge may be a geographic coordinate and/or an altitude (e.g., in the case of a three-dimensional boundary). The unique identifier generator 121 can then process the vector (e.g., apply a hash algorithm to the vector, concatenate the values in each element of the vector, etc.) to form the unique identifier. The unique identifier generator 121 can repeat these operations to determine unique identifiers for a plurality of units (where one or more units may be present in a particular structure).

The unique identifier generator 121 can also generate a persistent identifier for an individual real estate block (e.g., a set of real estate parcels that share a characteristic, such as location, neighborhood, subdivision, etc.), an individual real estate parcel, an individual structure located on an individual real estate parcel, and/or an individual unit located in an individual structure on an individual real estate parcel that can be based on (1) geometric land and/or building information, (2) a value that (uniquely) identifies a geographic cell (e.g., a quadrilateral bounded by four geodesics) derived based on a spherical projection (e.g., a value that corresponds to a geographic area corresponding to a location on the surface of Earth that includes individual points mapped to a mathematical sphere), and/or (3) a sequence number. The unique identifier generator 121 can generate a persistent identifier based on a first, second, and/or third intermediate identifier.

For example, the unique identifier generator 121 can obtain geographical coordinate information and/or topological information that defines a two-dimensional or three-dimensional boundary of a parcel. The unique identifier generator 121 can then determine and assign a first intermediate identifier to the block or parcel, where the first intermediate identifier is based on the two-dimensional or three-dimensional boundary (e.g., a representation of a vector that includes elements corresponding to the positions of joints and/or edges of the boundary, such as a hash of the vector, a concatenation of the values in the vector elements, etc.). As another example, the unique identifier generator 121 can obtain geographical coordinate information and/or structure architectural plans that define a two-dimensional or three-dimensional boundary of a structure. The unique identifier generator 121 can then determine and assign a first intermediate identifier to the structure, where the first intermediate identifier is based on the two-dimensional or three-dimensional boundary of the structure (e.g., a representation of a vector that includes elements corresponding to the positions of joints and/or edges of the boundary, such as a hash of the vector, a concatenation of the values in the vector elements, etc.). As another example, the unique identifier generator 121 can obtain geographical coordinate information and/or structure architectural plans that define a two-dimensional or three-dimensional boundary of a unit. The unique identifier generator 121 can then determine and assign a first intermediate identifier to the unit, where the first intermediate identifier is based on the two-dimensional or three-dimensional boundary of the unit (e.g., a representation of a vector that includes elements corresponding to the positions of joints and/or edges of the boundary, such as a hash of the vector, a concatenation of the values in the vector elements, etc.). The unique identifier generator 121 can repeat these operations to determine first intermediate identifiers for a plurality of blocks, for a plurality of parcels, for a plurality of structures (where one or more structures may be present on a particular parcel), and/or for a plurality of units (where one or more units may be present in a particular structure). In some embodiments, the two-dimensional or three-dimensional boundary of the structure (or block or parcel or unit) is represented by an exact or nearly exact boundary (e.g., within a threshold percentage of an exact boundary, such as within 1%, 0.1%, 0.001%, etc.) of the structure (or block or parcel or unit) (e.g., as indicated in structure architectural plans). In other embodiments, the two-dimensional or three-dimensional boundary of the structure (or block or parcel or unit) is represented by a rough boundary of the structure formed by combining one or more basic geometric shapes, such as circles, ovals, rectangles, squares, triangles, hexagons, cubes, cuboids, cones, cylinders, spheres, etc. (e.g., regular shapes that are symmetric rather than irregular shapes that may be freeform shapes and/or asymmetric). Using a rough boundary of a structure (or block or parcel or unit) rather than an exact or nearly exact boundary of a structure (or block or parcel or unit) may allow the unique identifier generator 121 to differentiate between block, parcel, structure, and/or unit splits and situations in which a slight modification is made to a block, parcel, structure, and/or unit that otherwise may not warrant the generation of a new unique identifier for the block, parcel, structure, and/or unit. For example, a slightly modified block, parcel, structure, and/or unit may have the same rough boundary as the unmodified block, parcel, structure, and/or unit but may not have the same exact or nearly exact boundary as the unmodified block, parcel, structure, and/or unit.

The unique identifier generator 121 can further generate a second intermediate identifier based on a geographic cell within which the block, parcel, structure, and/or unit is located. For example, the value that identifies a geographic cell may be referred to herein as a geographic cell identifier. The geographic cell identifier may be a multi-bit value (e.g., 32-bit value, 64-bit value, 128-bit value, etc.), where higher order bits represent a larger geographic area in which the geographic cell is located and lower order bits represent a smaller geographic area in which the geographic cell is located (e.g., each higher bit may represent a higher region, ranging from sub-millimeter level to sub-meter level to meter level to parcel level to block level to city level to state level to country level to continent level to hemisphere level and so on, as the bits are traversed from lower order bits to higher order bits). The unique identifier generator 121 may set the second intermediate identifier to be equal to the geographic cell identifier of the geographic cell in which the block, parcel, structure, and/or unit is located.

The unique identifier generator 121 can further generate a third intermediate identifier that may also be referred to herein as a sequence number. The sequence number can be a value that distinguishes between different parcels (or blocks or structures or units) that are located in the same geographic location and that have the same structural boundary or geometry. For example, individual condominiums in a high-rise condominium complex may share the same geographic location and structural boundary or geometry. The unique identifier generator 121 may assign each individual unit (e.g., each individual condominium) that shares the same geographic location and structural boundary or geometry a different sequence number. If, for example, the block, parcel, structure, and/or unit does not share a geographic location or structural boundary or geometry with another block, parcel, structure, and/or unit, then the unique identifier generator 121 may assign the block, parcel, structure, and/or unit a sequence number of 1 or 0.

The unique identifier generator 121 can generate a unique identifier for a block, parcel, structure, and/or unit by combining some or all of the first intermediate identifier, the second intermediate identifier, and/or the third intermediate identifier of the block, parcel, structure, and/or unit. For example, the system can concatenate the first intermediate identifier, the second intermediate identifier, and/or the third intermediate identifier in any order, can apply a mathematical function to some or all of the identifiers together (e.g., addition, subtraction, hash algorithm, etc.), can include some or all of the identifiers as separate elements in a vector that collectively represents the unique identifier for the block, parcel, structure, and/or unit, and/or the like.

In some instances, the unique identifier generator 121 can detect situations in which a block, parcel, structure, and/or unit is split (or merged or otherwise changed form). For example, the unique identifier generator 121 can periodically determine block, parcel, structure, and/or unit boundaries for one or more blocks, parcels, structures, and/or units by querying the property data store 130. If the unique identifier generator 121 determines that the current boundary for a block, parcel, structure, and/or unit is different than a previous boundary for the block, parcel, structure, and/or unit by a threshold value (e.g., the distance between an edge of the previous boundary (e.g., a North edge of the previous boundary) and a corresponding edge of the current boundary (e.g., a North edge of the current boundary) is greater than 3 feet, 5 feet, 10 feet, etc.; an edge of the current boundary is shorter or longer than a corresponding edge of the previous boundary by 3 feet, 5 feet, 10 feet, etc.; an area of the current boundary is smaller or larger than the area of the previous boundary by 10 square feet, 20 square feet, 100 square feet, etc.; etc.) or percentage (e.g., an edge of the current boundary is shorter or longer than a corresponding edge of the previous boundary by 50%, 55%, 60%, etc.; an area of the current boundary is smaller or larger than the area of the previous boundary by 25%, 50%, 55%, 60%, etc.; etc.), this may indicate that the block, parcel, structure, and/or unit has been split (or merged or otherwise changed form). For example, the unique identifier generator 121 may determine that the parcel has been split into two or more sub-parcels if the difference in boundaries indicates that the current boundary is smaller than the previous boundary, and the unique identifier generator 121 may determine that the parcel has been merged with one or more other parcels to form a larger parcel if the difference in boundaries indicates that the current boundary is larger than the previous boundary. In response, the unique identifier generator 121 may generate a new unique identifier for the block, parcel, structure, and/or unit and/or for the new blocks, parcels, structures, and/or units created by the split or change in form in a manner as described above. In some cases, the new unique identifier may be formed by the unique identifier generator 121 by creating a new third intermediate identifier (leaving the previous first and second identifiers the same), such that the sequence number may differentiate one portion of a split block, parcel, structure, and/or unit from another portion of the split block, parcel, structure, and/or unit. The property data linker 122 may link the old unique identifier for the block, parcel, structure, and/or unit with the unique identifier for the new block, parcel, structure, and/or unit.

The property data linker 122 can link unique identifiers or persistent identifiers generated by the unique identifier generator 121 with corresponding property data records stored in the property data store 130. For example, the property data linker 122 can update the property data store 130 by including a unique identifier or persistent identifier in a property data record from which data was obtained to generate the unique identifier. In some cases, a parcel may include multiple structures and/or a structure may include multiple units. The property data linker 122 may create, for a parcel, a plurality of property data records, where a first property data record corresponds to the parcel and includes a linkage between a unique identifier for the parcel and the property data of the parcel, one or more second property data records each corresponds to a different structure and includes a linkage between a unique identifier for the respective structure and the property data of the respective structure, and/or one or more third property data records each corresponds to a different unit in a structure on the parcel and includes a linkage between a unique identifier for the respective unit and the property data of the respective unit. Thus, the property data linker 122 may create a hierarchy of linked unique identifiers and property data linked thereto for each property, where the linked unique identifiers for a property can include a parcel unique identifier (which may fall in a highest tier of the hierarchy), one or more structure unique identifiers (which may fall in a second-highest tier of the hierarchy), and/or one or more structure unit unique identifiers (which may fall in a third-highest tier of the hierarchy). Specifically, a parcel unique identifier may be linked to each structure unique identifier, and each structure unique identifier may be linked to those structure unit unique identifier(s) that correspond to units that are within the structure corresponding to the respective structure unique identifier. Each unique identifier may be further linked with property data corresponding to the subject of the unique identifier (e.g., a parcel, a structure, a unit, a block, etc.). The linkage may allow the geospatial property identifier system 120 to respond to a query for information on a specific parcel, structure, and/or unit by identifying the unique identifier of the specific parcel, structure, and/or unit, identifying property data linked to the identified unique identifier, identifying other unique identifier(s) linked to the identified unique identifier, identifying other property data linked to the other unique identifier(s), and retrieving some or all of the identified property data and/or other property data for display to a user via the user device 102 in response to the query.

The hazard risk estimator 123 can apply hazard zones to unique identifiers or persistent identifiers, regardless of whether the identifiers correspond to blocks, parcels, structures, or units. For example, based on the linking performed by the property data linker 122, the hazard risk estimator 123 can query the property data store 130 to identify a geographic location linked to a unique identifier or persistent identifier. The hazard risk estimator 123 may have access to hazard data, including the likelihood of one or more types of hazards affecting different geographic locations. The hazard risk estimator 123 can then link or categorize a unique identifier or persistent identifier to a hazard zone corresponding to a type of hazard that is likely to affect the geographic location linked to the unique identifier. The hazard risk estimator 123 can repeat this operation for one or more unique identifiers or persistent identifiers. The hazard risk estimator 123 may update some or all of the property data records in the property data store 130 to include an indication of a hazard zone linked to the unique identifier of the respective property data record.

The user interface generator 124 can generate user interface data that, when rendered and executed by a user device 102, causes a user device 102 to display a user interface that depicts unique identifiers and/or persistent identifiers in relation to other property data.

The user interface may also allow a user to submit queries for property data. For example, a user can use a user device 102 to enter a query for property data, where the query identifies an address, a name of an owner, an assessor parcel number, a geocode, geographical coordinates (e.g., latitudinal and longitudinal coordinates), a parcel unique identifier, a structure unique identifier, a structure unit unique identifier, and/or any other type of unique identifier or property data. In response, the user interface generator 124 can query the property data store 130 to identify property data and/or unique identifier(s) linked to the submitted query. For example, if the query includes an address, a name of an owner, an assessor parcel number, or any other type of property data, the user interface generator 124 can query the property data store 130 for a unique identifier linked to the information included in the query. The unique identifier linked to the information included in the query may be a parcel unique identifier, a structure unique identifier, or a structure unit unique identifier. Once the user interface generator 124 receives the unique identifier from the property data store 150, the user interface generator 124 can further query the property data store 150 for property data linked to the received unique identifier. The property data store 150 may return the linked property data (as linked by the property data linker 122) and the user interface generator 124 can generate updated user interface data that, when rendered by the user device 102, causes the user device 102 to display an updated user interface that depicts the received unique identifier and/or the linked property data.

Optionally, the user interface generator 124 can retrieve additional data for display in the user interface. The user interface generator 124 can retrieve additional data to not only show the user property data for a requested parcel, structure, or unit, but also to show (1) the relationship between a requested parcel and structures and/or units that reside therein; (2) the relationship between a requested structure and a parcel upon which the structure resides, other structure(s) residing on the parcel, and/or units that reside therein; (3) the relationship between a requested unit and a parcel upon which the unit is located and/or the structure within which the unit is located; and/or (4) property data of the related parcel, structure(s), and/or unit(s). For example, if the received unique identifier is a parcel unique identifier, the user interface generator 124 may query the property data store 150 for unique identifier(s) linked to the parcel unique identifier (e.g., structure unique identifier(s), structure unit unique identifier(s), etc.) and property data linked to those unique identifier(s) that are linked to the parcel unique identifier. The user interface generator 124 may then cause the user interface to be updated to display some or all of the unique identifier(s) that are linked to the parcel unique identifier and/or some or all of the property data linked to the unique identifier(s) that are linked to the parcel unique identifier. In this way, while the user may have submitted a query for information on the parcel, the user interface generator 124 may cause a user interface to be displayed on a user device 102 that provides a user with an incomplete or complete picture of not only the layout of the parcel, but also of the structure(s) residing on the parcel and/or of the unit(s) located within each structure residing on the parcel. As another example, if the received unique identifier is a structure unique identifier, the user interface generator 124 may query the property data store 150 for unique identifier(s) linked to the structure unique identifier (e.g., a parcel unique identifier, structure unit unique identifier(s), etc.) and property data linked to those unique identifier(s) that are linked to the structure unique identifier. The user interface generator 124 may then cause the user interface to be updated to display some or all of the unique identifier(s) that are linked to the structure unique identifier and/or some or all of the property data linked to the unique identifier(s) that are linked to the structure unique identifier. In this way, while the user may have submitted a query for information on a structure, the user interface generator 124 may cause a user interface to be displayed on a user device 102 that provides a user with an incomplete or complete picture of not only the structure, but also of the layout of the parcel on which the structure resides and/or of the unit(s) located within the structure. As another example, if the received unique identifier is a structure unit unique identifier, the user interface generator 124 may query the property data store 150 for unique identifier(s) linked to the structure unit unique identifier (e.g., a parcel unique identifier, structure unique identifier(s), etc.) and property data linked to those unique identifier(s) that are linked to the structure unit unique identifier. The user interface generator 124 may then cause the user interface to be updated to display some or all of the unique identifier(s) that are linked to the structure unit unique identifier and/or some or all of the property data linked to the unique identifier(s) that are linked to the structure unit unique identifier. In this way, while the user may have submitted a query for information on a unit, the user interface generator 124 may cause a user interface to be displayed on a user device 102 that provides a user with an incomplete or complete picture of not only the unit, but also of the layout of the parcel on which a structure that includes the unit resides and/or of the structure that includes the unit.

The property data store 130 may store property data associated with one or more parcels, one or more structures on one or more parcels (e.g., unique identifier (including persistent identifier) for a parcel and/or one or more structures on the parcel, lot size of the parcel, number of bedrooms in one or more structures on the parcel, number of bathrooms in one or more structures on the parcel, square footage of one or more structures on the parcel, street address of the parcel and/or one or more structures located therein, neighborhood in which the parcel resides, an identification of the homeowner's association to which the parcel is subject, year built of one or more structures on the parcel, roof material of one or more structures on the parcel, siding material of one or more structures on the parcel, window type of one or more structures on the parcel, parcel owner, property name, parcel name, etc.), and/or one or more units located within one or more structures. While the property data store 130 is depicted as being external to the geospatial property identifier system 120, this is not meant to be limiting. For example, not shown, the property data store 130 can be located internal to the geospatial property identifier system 120.

### Example Block Diagrams for Generating Unique Identifiers

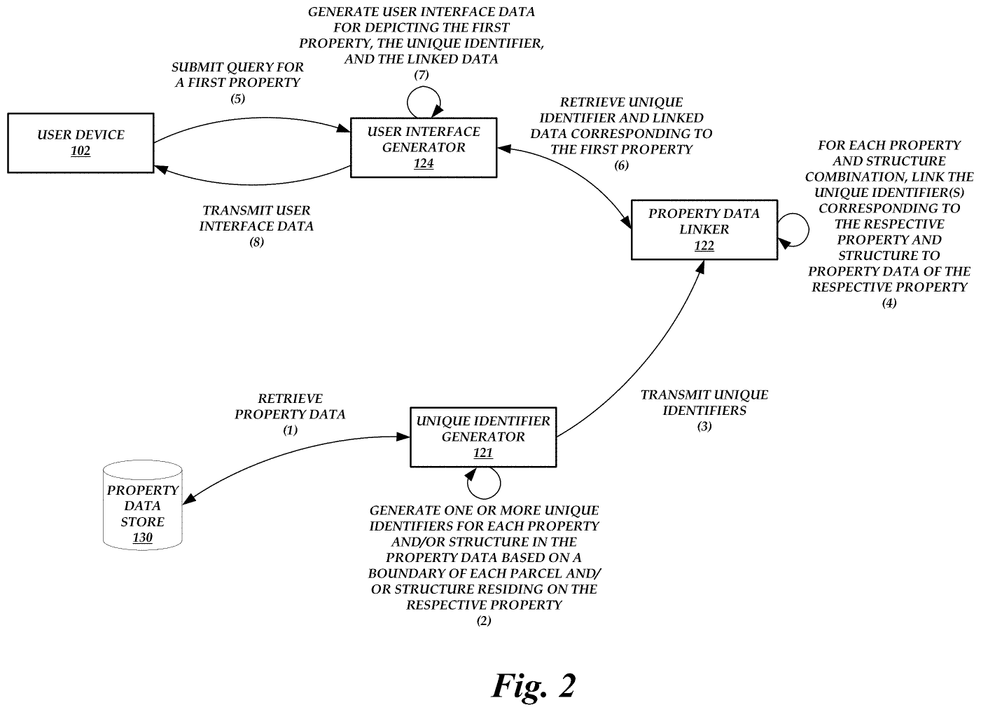

FIG. 2 is a flow diagram illustrating the operations performed by the components of the operating environment 100 of FIG. 1 to generate a unique identifier. As illustrated in FIG. 2, the unique identifier generator 121 can retrieve property data from the property data store 150 at (1). The unique identifier generator 121 can generate one or more unique identifiers for each property and/or structure in the property data based on a boundary of each parcel and/or structure residing on the respective property at (2). Thus, the unique identifier generator 121 may generate multiple identifiers for at least some parcels, where one identifier corresponds to the parcel itself and one or more other identifiers each correspond to a structure residing on the parcel. The unique identifier generator 121 can transmit the unique identifiers to the property data linker 122 at (3).

The property data linker 122 can, for each property and structure combination, link the unique identifier(s) corresponding to the respective property and structure to property data of the respective property at (4). Optionally, the property data linker 122 can update the property data store 130 to include the linked data.

Asynchronously from operations (1)-(4), a user device 102 can submit a query for a first property to the user interface generator 124 at (5). The user interface generator 124 can retrieve from the property data linker 122 (or the property data store 130) the unique identifier and linked data corresponding to the first property at (6). The user interface generator 124 can then generate user interface data for depicting the first property, the unique identifier, and/or the linked data at (7), and transmit the user interface data to the user device 102 at (8). As a result, the user device 102 may process the user interface data and display a user interface depicting the first property, the unique identifier, and/or the linked data.

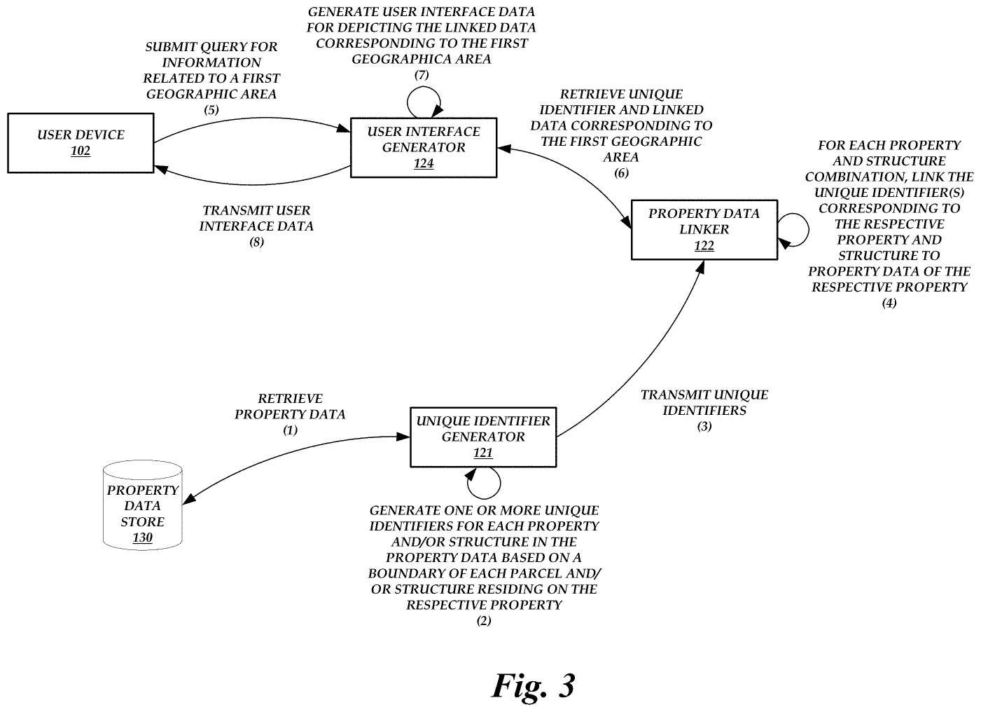

FIG. 3 is a flow diagram illustrating the operations performed by the components of the operating environment 100 of FIG. 1 to generate a unique identifier. As illustrated in FIG. 3, the unique identifier generator 121 can retrieve property data from the property data store 150 at (1). The unique identifier generator 121 can generate one or more unique identifiers for each property and/or structure in the property data based on a boundary of each parcel and/or structure residing on the respective property at (2). Thus, the unique identifier generator 121 may generate multiple identifiers for at least some parcels, where one identifier corresponds to the parcel itself and one or more other identifiers each correspond to a structure residing on the parcel. The unique identifier generator 121 can transmit the unique identifiers to the property data linker 122 at (3).

The property data linker 122 can, for each property and structure combination, link the unique identifier(s) corresponding to the respective property and structure to property data of the respective property at (4). Optionally, the property data linker 122 can update the property data store 130 to include the linked data.

Asynchronously from operations (1)-(4), a user device 102 can submit a query for information related to a first geographic area at (5). The user interface generator 124 can retrieve from the property data linker 122 (or the property data store 130) the unique identifier and linked data corresponding to the first geographic area at (6). The user interface generator 124 can then generate user interface data for depicting the linked data corresponding to the first geographic area at (7), and transmit the user interface data to the user device 102 at (8). As a result, the user device 102 may process the user interface data and display a user interface depicting the linked data in relation to the first geographic area.

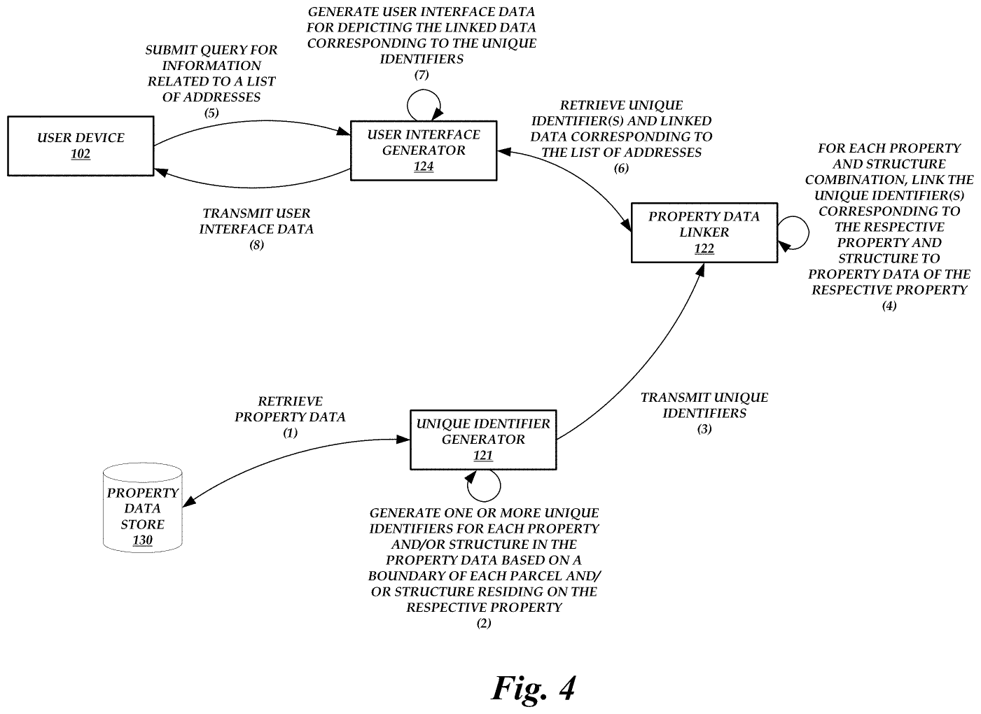

FIG. 4 is a flow diagram illustrating the operations performed by the components of the operating environment 100 of FIG. 1 to generate a unique identifier. As illustrated in FIG. 4, the unique identifier generator 121 can retrieve property data from the property data store 150 at (1). The unique identifier generator 121 can generate one or more unique identifiers for each property and/or structure in the property data based on a boundary of each parcel and/or structure residing on the respective property at (2). Thus, the unique identifier generator 121 may generate multiple identifiers for at least some parcels, where one identifier corresponds to the parcel itself and one or more other identifiers each correspond to a structure residing on the parcel. The unique identifier generator 121 can transmit the unique identifiers to the property data linker 122 at (3).

The property data linker 122 can, for each property and structure combination, link the unique identifier(s) corresponding to the respective property and structure to property data of the respective property at (4). Optionally, the property data linker 122 can update the property data store 130 to include the linked data.

Asynchronously from operations (1)-(4), a user device 102 can submit a query for information related to a list of addresses (e.g., one or more addresses) at (5). The user interface generator 124 can retrieve from the property data linker 122 (or the property data store 130) the unique identifier(s) and linked data corresponding to the list of addresses at (6). The user interface generator 124 can then generate user interface data for depicting the addresses corresponding to the unique identifiers at (7), and transmit the user interface data to the user device 102 at (8). As a result, the user device 102 may process the user interface data and display a user interface depicting the linked data in relation to the list of addresses.

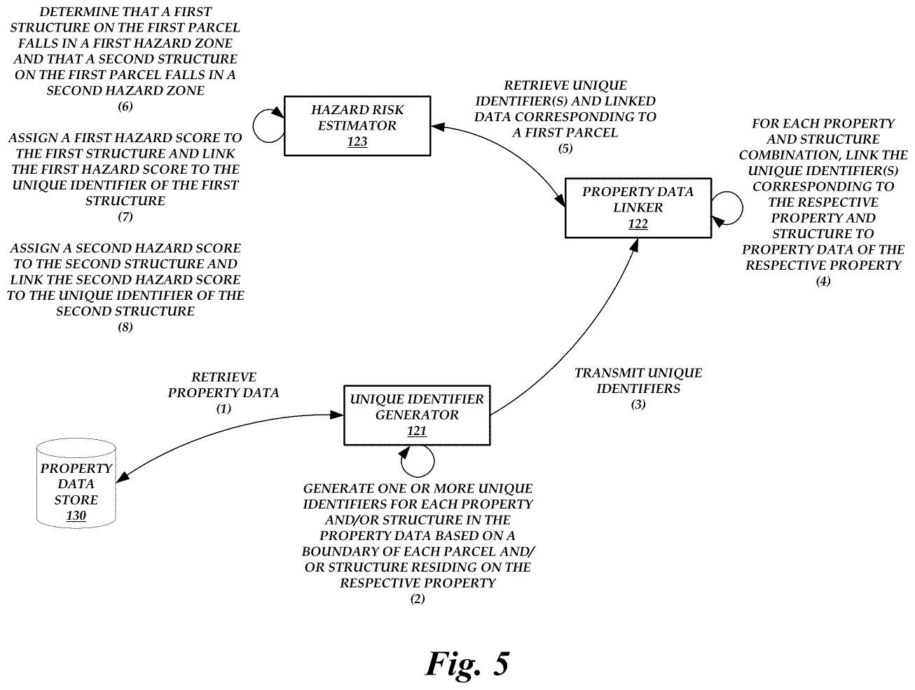

FIG. 5 is a flow diagram illustrating the operations performed by the components of the operating environment 100 of FIG. 1 to generate a unique identifier. As illustrated in FIG. 5, the unique identifier generator 121 can retrieve property data from the property data store 150 at (1). The unique identifier generator 121 can generate one or more unique identifiers for each property and/or structure in the property data based on a boundary of each parcel and/or structure residing on the respective property at (2). Thus, the unique identifier generator 121 may generate multiple identifiers for at least some parcels, where one identifier corresponds to the parcel itself and one or more other identifiers each correspond to a structure residing on the parcel. The unique identifier generator 121 can transmit the unique identifiers to the property data linker 122 at (3).

The property data linker 122 can, for each property and structure combination, link the unique identifier(s) corresponding to the respective property and structure to property data of the respective property at (4). Optionally, the property data linker 122 can update the property data store 130 to include the linked data.

Asynchronously from operations (1)-(4), the hazard risk estimator 123 can retrieve from the property data linker 122 (or the property data store 130) the unique identifier(s) and linked data corresponding to a first parcel at (5). The hazard risk estimator 123 may then determine that a first structure on the first parcel falls in a first hazard zone and that a second structure on the first parcel falls in a second hazard zone at (6). As a result, the hazard risk estimator 123 can assign a first hazard score to the first structure and link the first hazard score to the unique identifier of the first structure at (7). The first hazard score may correspond to a likelihood that a hazard associated with the first hazard zone will impact the first structure. The hazard risk estimator 123 can also assign a second hazard score to the second structure and link the second hazard score to the unique identifier of the second structure at (8). The second hazard score may correspond to a likelihood that a hazard associated with the second hazard zone will impact the second structure.

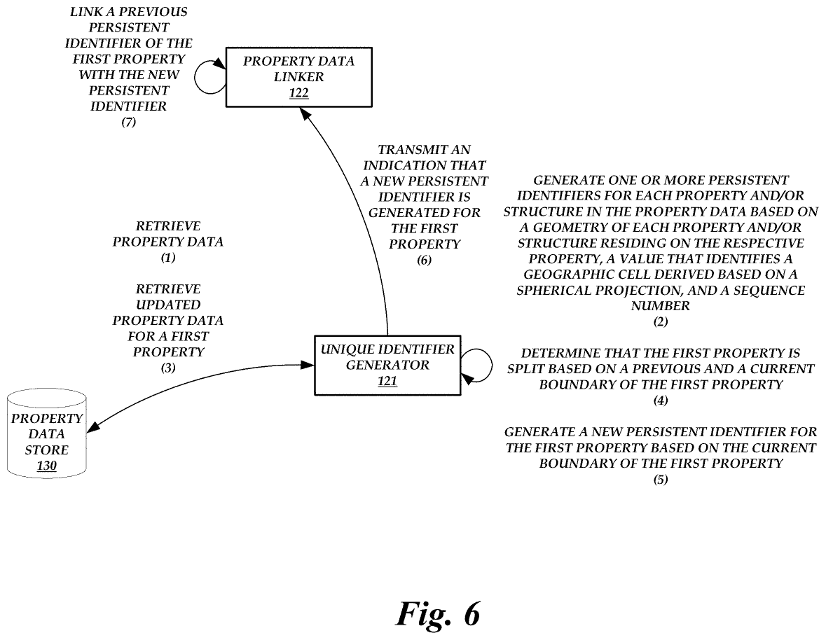

FIG. 6 is a flow diagram illustrating the operations performed by the components of the operating environment 100 of FIG. 1 to generate a persistent identifier. As illustrated in FIG. 6, the unique identifier generator 121 can retrieve property data from the property data store 150 at (1).

The unique identifier generator 121 can generate one or more persistent identifiers for each property and/or structure in the property data based on a geometry of each property and/or structure residing on the respective property, a value that identifies a geographic cell derived based on a spherical projection, and a sequence number at (2).

At a later time, the unique identifier generator 121 may retrieve updated property data for a first property from the property data store 130 at (3). For example, the updated property data may be updated in response to a change in a parcel. The unique identifier generator 121 can determine that the first property is split based on a previous and a current boundary of the first property at (4). In particular, the unique identifier generator 121 may determine that the first property is split if the difference between a previous boundary of the property or parcel and a current boundary of the property or parcel is greater than a threshold value or percentage. In response, the unique identifier generator 121 can generate a new persistent identifier for the first property based on the current boundary of the first property at (5).

The unique identifier generator 121 can transmit an indication that a new persistent identifier is generated for the first property to the property data linker 122 at (6). The property data linker 122 can link a previous persistent identifier of the first property with the new persistent identifier at (7). Optionally, the property data linker 122 may update a property data record in the property data store 130 corresponding to the first property to include the new persistent identifier. Optionally, the user interface generator 124 can generate user interface data to transmit to the user device 102 that causes the user device 102 to display a user interface in which the change to the first property is depicted in relation to the previous and current persistent identifiers.

### Use Cases

The unique identifier of a parcel (or structure) may link an address of the parcel, an owner of the parcel, a property name, a parcel name, and/or the like. Thus, entering a search query for any of the linked information in a user interface displayed by the user device 102 can result in search results that include the other linked information and/or the unique identifier itself.

As an example, a telecommunications service entity (e.g., phone company, cable company, wireless phone company, etc.) can request information on one or more potential customers in a particular area. The unique identifier of a parcel may be linked to unique identifier(s) of structure(s) located on the parcel. As a result, the geospatial property identifier system 120 can identify one or more parcel unique identifiers corresponding to parcel(s) that have a boundary that falls within the particular area. The geospatial property identifier system 120 can then identify one or more structure unique identifiers associated with the identifier parcel unique identifier(s). If a parcel includes multiple structures, the geospatial property identifier system 120 can then use the structure unique identifiers to identify the addresses of each of the individual structures (e.g., because the structure unique identifier may be associated with and link an address, a structure owner, etc.). The addresses can then be returned as search results to the user device 102 of the telecommunications service entity.

As another example, a commercial property underwriter can provide a list of addresses and request details on the corresponding properties. Based on the addresses, the geospatial property identifier system 120 can identify one or more parcel unique identifiers that correspond to the addresses, one or more structure unique identifiers that each correspond to one of the parcel unique identifiers, and/or information related to the structure(s) corresponding to the structure unique identifier(s). The geospatial property identifier system 120 can then return the related information to the user device 102 of the commercial property underwriter as search results.

As another example, in some situations a portion of a parcel falls in one hazard zone (e.g., flood zone) and another portion of the parcel falls in another hazard zone. Often, one structure on the parcel falls in one hazard zone and another structure on the parcel falls in another hazard zone. Generally, the parcel is assigned to the hazard zone in which a majority of the parcel falls, and the parcel may be assigned a hazard risk score (e.g., a score representing a likelihood that a hazard may occur and cause damage to the parcel) based on the assigned hazard zone. However, this is not an accurate reflection of the likelihood that a hazard may affect the parcel. Thus, the geospatial property identifier system 120 can use structure unique identifiers to assign hazard risk scores to individual structures on a parcel. In situations in which one structure falls in one hazard zone and another structure falls in another hazard zone, the geospatial property identifier system 120 can assign a different hazard risk score to each structure that more accurately reflects the actual hazard risk faced by the structure (and parcel).

As another example, an oil and gas customer can request a unique persistent identifier for parcels and structures so that the oil and gas customer can use property data as a foundation for linking the oil and gas customer's data assets. The geospatial property identifier system 120 can enable this linking using parcel and/or structure unique identifiers.

As another example, the geospatial property identifier system 120 can enable the connection of the property world (e.g., via the unique identifier) with the spatial world to provide users with tools to perform more accurate site selection (e.g., retail companies expanding into new areas, builders looking for land, investors seeking rental properties, etc.).

The geospatial property identifier system 120 may include a data store or communicate with an external data store to track unique identifiers over time (e.g., the property data store 130). For example, the data store may store, in association with a particular block, parcel, and/or structure, the unique identifier(s) generated by the geospatial property identifier system 120 for the particular block, parcel, and/or structure over time. Thus, the geospatial property identifier system 120 may create and/or cause the data store to maintain a lineage table or other data structure that indicates the history of unique identifiers.

In further embodiments, the geospatial property identifier system 120 can use other attributes of a block, parcel, and/or structure to disambiguate and distinguish between two or more similar blocks, parcels, and/or structures (such as by combining these attribute(s) with the unique identifier to form a modified unique identifier). For example, the geospatial property identifier system 120 can use a tax rate of the tax jurisdiction in which a block, parcel, and/or structure is located, can use an elevation, altitude, and/or floor number of the block, parcel, and/or structure, and/or the like.

As another example, the geospatial property identifier system 120 may use persistent identifiers to allow users to perform time-series analysis to identify market and/or sales trends (e.g., by understanding the life cycle of parcel boundaries, such as when parcels split, merge, etc.) and/or to monitor portfolios of parcels associated with different entities at the parcel and/or structure level.

While the present disclosure describes the geospatial property identifier system 120 as generating unique identifiers for blocks, parcels, and/or structures, this is not meant to be limiting. For example, the geospatial property identifier system 120 can use the same or similar techniques described herein to generate unique identifiers for any item or area that may be located on a parcel, such as a kitchen, a bedroom, a bathroom, a shed, a garage, a pool, and/or the like.

Furthermore, a user can use the user device 102 to submit a query and receive query results that are displayed in a user interface regardless of which type of unique identifier the geospatial property identifier system 120 generated. Thus, the communications between the user device 102 and the user interface generator 124 described herein can apply to any type of unique identifier and for any type of query submitted by the user device 102.

### Example Property Information Retrieval Routines

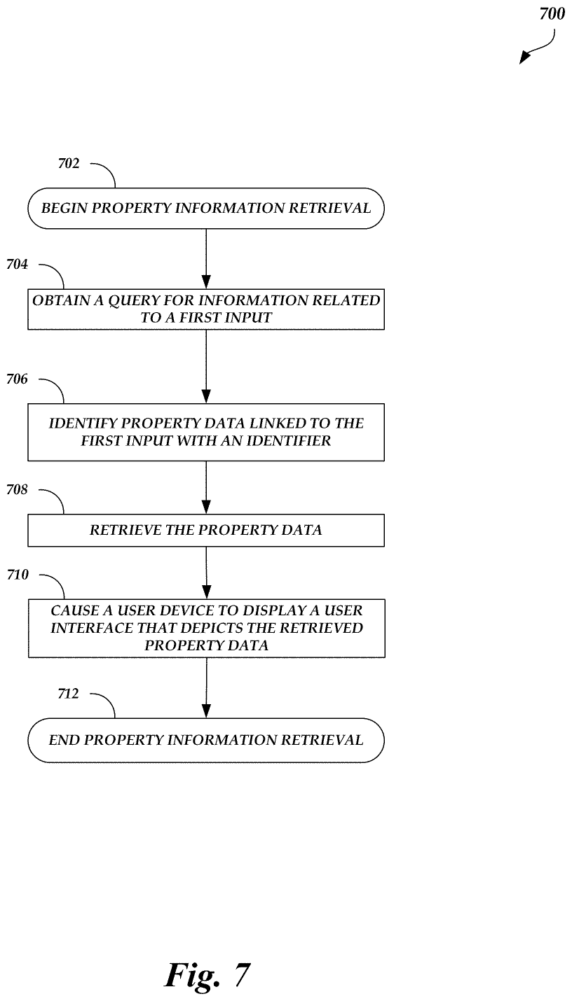

FIG. 7 is a flow diagram depicting an example, property information retrieval routine 700 illustratively implemented by a geospatial property identifier system, according to one embodiment. As an example, the geospatial property identifier system 120 of FIG. 1 can be configured to execute the property information retrieval routine 700. The property information retrieval routine 700 begins at block 702.

At block 704, a query for information related to a first input is received. For example, the first input can be a street address, name of an owner of a parcel, a geocode, geographic coordinates, an assessor parcel number, a unique identifier, and/or the like. The query may be received from a user device 102 and entered in a user interface displayed on the user device 102.

At block 706, property data linked to the first input with an identifier is identified. For example, the identifier may be a persistent identifier. the property data may be stored in the property data store 130 (including the persistent identifier). The persistent identifier may be generated based at least in part on a physical boundary of a structure corresponding to the first input, a geographic cell identifier, and/or a sequence number.

At block 708, the property data is retrieved. For example, the property data may be retrieved from the property data store 130.

At block 710, a user device is caused to display a user interface that depicts the retrieved property data. The user interface may further depict the identifier. After the user device is caused to display the user interface, the property information retrieval routine 700 ends, as shown at block 712.

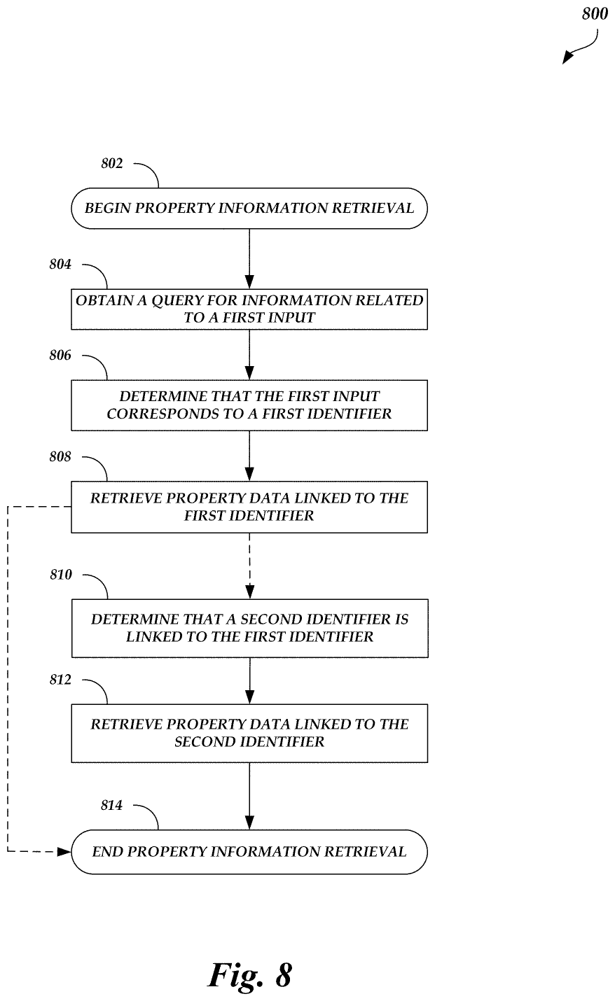

FIG. 8 is another flow diagram depicting an example, property information retrieval routine 800 illustratively implemented by a geospatial property identifier system, according to one embodiment. As an example, the geospatial property identifier system 120 of FIG. 1 can be configured to execute the property information retrieval routine 800. The property information retrieval routine 800 begins at block 802.

At block 804, a query for information related to a first input is received. For example, the first input can be a street address, name of an owner of a parcel, a geocode, geographic coordinates, an assessor parcel number, a unique identifier, and/or the like. The query may be received from a user device 102 and entered in a user interface displayed on the user device 102.

At block 806, a determination is made that the first input corresponds to a first identifier. For example, the first input may be linked to the first identifier. The first identifier may be a block unique identifier, a parcel unique identifier, a structure unique identifier, a structure unit unique identifier, and/or the like.

At block 808, property data linked to the first identifier is retrieved. For example, the property data may include any property data linked to the first identifier other than or including the first input.

Optionally, the property information retrieval routine 800 ends after retrieval of the property data linked to the first identifier, as shown at block 814. Alternatively, the property information retrieval routine 800 proceeds to block 810 after retrieval of the property data linked to the first identifier. At block 810, a determination is made that a second identifier is linked to the first identifier. For example, if the first identifier is a parcel unique identifier, then the second identifier may be a structure unique identifier corresponding to a structured residing on the parcel identified by the parcel unique identifier or a structure unit unique identifier corresponding to a unit that is within a structure residing on the parcel identified by the parcel unique identifier. As another example, if the first identifier is a structure unique identifier, then the second identifier may be a parcel unique identifier corresponding to a parcel that includes the structure identified by the structure unique identifier or a structure unit unique identifier corresponding to a unit that is located within the structure identified by the structure unique identifier. As another example, if the first identifier is a structure unit unique identifier, then the second identifier may be a parcel unique identifier corresponding to a parcel that includes a structure within which the unit identified by the structure unit unique identifier resides or a structure unique identifier corresponding to the structure within which the unit identified by the structure unit unique identifier resides.

At block 812, property data linked to the second identifier is retrieved. For example, the property data may include any property data linked to the second identifier. After the property data linked to the second identifier is retrieved, the property information retrieval routine 800 ends, as shown at block 814.

Optionally, the property information retrieval routine 800 ends after retrieval of the property data linked to the second identifier, as shown at block 814. Alternatively, the property information retrieval routine 800 continues and a determination is made that a third identifier is linked to one of the first identifier or the second identifier. For example, if the first identifier is a parcel unique identifier that identifies a parcel and the second identifier is a structure unique identifier that identifies a structure that resides on the parcel, then the third identifier may be (1) a second structure unique identifier corresponding to a second structured residing on the parcel identified by the parcel unique identifier or (2) a structure unit unique identifier corresponding to a unit that is within the structure identified by the structure unique identifier. As another example, if the first identifier is a structure unique identifier that identifies a structure on a parcel and the second identifier is a structure unit unique identifier that identifies a unit within the structure, then the third identifier may be (1) a parcel unique identifier corresponding to the parcel that includes the structure identified by the structure unique identifier or (2) a second structure unit unique identifier corresponding to a second unit that is located within the structure identified by the structure unique identifier. As another example, if the first identifier is a structure unique identifier that identifies a structure on a parcel and the second identifier is a parcel unique identifier that identifies the parcel, then the third identifier may be a structure unit unique identifier corresponding to a unit that is located within the structure identified by the structure unique identifier. As another example, if the first identifier is a structure unit unique identifier that identifies a unit within a structure on a parcel and the second identifier is a structure unique identifier that identifies the structure, then the third identifier may be a parcel unique identifier corresponding to the parcel that includes the structure. Optionally, the property information retrieval routine 800 can continue to identify any number of other unique identifiers that are linked to the first, second, and/or third identifiers and retrieve corresponding property data for eventual display in a user interface. In this way, a user may be provided with visual information that indicates the relationship between a parcel, structure(s) on the parcel, and/or the unit(s) within the structure(s).

Optionally, prior to the property information retrieval routine 800 ending, a user device is caused to display a user interface that depicts the retrieved property data. The user interface may further depict the first identifier, the second identifier, and/or any other identifies for which property data is retrieved.

### ADDITIONAL EMBODIMENTS

Various example user devices 102 are shown in FIG. 1, including a desktop computer, laptop, and a mobile phone, each provided by way of illustration. In general, the user devices 102 can be any computing device such as a desktop, laptop or tablet computer, personal computer, wearable computer, server, personal digital assistant (PDA), hybrid PDA/mobile phone, mobile phone, electronic book reader, set-top box, voice command device, camera, digital media player, and the like. A user device 102 may execute an application (e.g., a browser, a stand-alone application, etc.) that allows a user to submit queries that reference any linked property data (including unique identifiers) to view the corresponding linked property data.

The network 110 may include any wired network, wireless network, or combination thereof. For example, the network 110 may be a personal area network, local area network, wide area network, over-the-air broadcast network (e.g., for radio or television), cable network, satellite network, cellular telephone network, or combination thereof. As a further example, the network 110 may be a publicly accessible network of linked networks, possibly operated by various distinct parties, such as the Internet. In some embodiments, the network 110 may be a private or semi-private network, such as a corporate or university intranet. The network 110 may include one or more wireless networks, such as a Global System for Mobile Communications (GSM) network, a Code Division Multiple Access (CDMA) network, a Long Term Evolution (LTE) network, or any other type of wireless network. The network 110 can use protocols and components for communicating via the Internet or any of the other aforementioned types of networks. For example, the protocols used by the network 110 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or logic circuitry that implements a state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system for retrieving property information, the system comprising:
memory that stores computer-executable instructions; and
a processor in communication with the memory, wherein the computer-executable instructions, when executed by the processor, cause the processor to:
obtain a query for information related to a first input;
determine that the first input corresponds to a first identifier, wherein the first identifier is generated based at least in part on a physical boundary of one of a parcel, a structure, or a unit corresponding to the first input;
retrieve property data linked to the first identifier; and
cause a user device to display a user interface that depicts the retrieved property data.

2. The system of claim 1, wherein the computer-executable instructions, when executed, further cause the processor to:
determine that a second identifier is linked to the first identifier;
retrieve second property data linked to the second identifier; and
cause the user device to display the user interface that depicts the retrieved property data and the retrieved second property data.

3. The system of claim 2, wherein the first identifier comprises a parcel unique identifier corresponding to a parcel, and wherein the second identifier comprises a structure unique identifier corresponding to a structure that resides on the parcel.

4. The system of claim 2, wherein the first identifier comprises a structure unit unique identifier corresponding to a unit in a structure on a parcel, and wherein the second identifier comprises a structure unique identifier corresponding to the structure.

5. The system of claim 2, wherein the computer-executable instructions, when executed, further cause the processor to:
determine that a third identifier is linked to one of the first identifier or the second identifier;
retrieve second property data linked to the third identifier; and
cause the user device to display the user interface that depicts the retrieved property data, the retrieved second property data, and the retrieved third property data.

6. The system of claim 5, wherein the first identifier comprises a parcel unique identifier corresponding to a parcel and the second identifier comprises a structure unique identifier corresponding to a structure that resides on the parcel, and wherein the third identifier comprises a structure unit unique identifier corresponding to a unit within the structure that resides on the parcel.

7. The system of claim 5, wherein the first identifier comprises a parcel unique identifier corresponding to a parcel and the second identifier comprises a first structure unique identifier corresponding to a first structure that resides on the parcel, and wherein the third identifier comprises a second structure unique identifier corresponding to a second structure that resides on the parcel.

8. The system of claim 5, wherein the first identifier comprises a structure unique identifier corresponding to a structure that resides on a parcel and the second identifier comprises a first structure unit unique identifier corresponding to a first unit within the structure that resides on the parcel, and wherein the third identifier comprises a second structure unit unique identifier corresponding to a second unit within the structure that resides on the parcel.

9. The system of claim 5, wherein the first identifier comprises a structure unit unique identifier corresponding to a unit in a structure on a parcel and the second identifier comprises a structure unique identifier corresponding to the structure on the parcel, and wherein the third identifier comprises a parcel unique identifier corresponding to the parcel.

10. The system of claim 1, wherein the first identifier comprises a parcel unique identifier corresponding to a parcel, and wherein the computer-executable instructions, when executed, further cause the processor to:
determine that a current boundary of the parcel is different than a previous boundary of the parcel by a threshold value;
determine that the parcel has one of split into a first sub-parcel and a second sub-parcel or merged with a second parcel to form a third parcel based on the determination that the current boundary is different than the previous boundary by the threshold value;
generate a second identifier for the parcel based on the current boundary; and
link the first identifier with the second identifier.

11. The system of claim 1, wherein the first input comprises one of an address, a name of an owner, a geocode, geographic coordinates, an assessor parcel number, or a second identifier.

12. A computer-implemented method for retrieving property information, the computer-implemented method comprising:
obtaining a query for information related to a first input;
determining that the first input corresponds to a first identifier, wherein the first identifier is generated based at least in part on a physical boundary of one of a parcel, a structure, or a unit corresponding to the first input;
retrieving property data linked to the first identifier; and
causing a user device to display a user interface that depicts the retrieved property data.

13. The computer-implemented method of claim 12, further comprising:
determining that a second identifier is linked to the first identifier;
retrieving second property data linked to the second identifier; and
causing the user device to display the user interface that depicts the retrieved property data and the retrieved second property data.

14. The computer-implemented method of claim 13, wherein the first identifier comprises a parcel unique identifier corresponding to a parcel, and wherein the second identifier comprises a structure unique identifier corresponding to a structure that resides on the parcel.

15. The computer-implemented method of claim 13, further comprising:
determining that a third identifier is linked to one of the first identifier or the second identifier;
retrieving second property data linked to the third identifier; and
causing the user device to display the user interface that depicts the retrieved property data, the retrieved second property data, and the retrieved third property data.

16. The computer-implemented method of claim 15, wherein the first identifier comprises a structure unit unique identifier corresponding to a unit in a structure on a parcel and the second identifier comprises a structure unique identifier corresponding to the structure on the parcel, and wherein the third identifier comprises a parcel unique identifier corresponding to the parcel.

17. The computer-implemented method of claim 12, wherein the first identifier comprises a parcel unique identifier corresponding to a parcel, and wherein the computer-implemented method further comprises:
determining that a current boundary of the parcel is different than a previous boundary of the parcel by a threshold value;
determining that the parcel has one of split into a first sub-parcel and a second sub-parcel or merged with a second parcel to form a third parcel based on the determination that the current boundary is different than the previous boundary by the threshold value;
generating a second identifier for the parcel based on the current boundary; and
linking the first identifier with the second identifier.

18. A non-transitory, computer-readable medium comprising computer-executable instructions for retrieving property information, wherein the computer-executable instructions, when executed by a computer system, cause the computer system to:
obtain a query for information related to a first input;
determine that the first input corresponds to a first identifier, wherein the first identifier is generated based at least in part on a physical boundary of one of a parcel, a structure, or a unit corresponding to the first input;
retrieve property data linked to the first identifier; and
cause a user device to display a user interface that depicts the retrieved property data.

19. A computer-implemented method for retrieving property information, the computer-implemented method comprising:
obtaining a query for information related to a first input;
identifying property data linked to the first input using an identifier; and
causing a user device to display a user interface that depicts the identified property data.

20. The computer-implemented method of claim 19, further comprising generating the identifier based at least in part on a physical boundary of a structure at the first input and a value that identifies a geographic cell derived based on a spherical projection.

21. The computer-implemented method of claim 20, wherein the value that identifies the geographical cell derived based on the spherical projection comprises a value that corresponds to a geographic area corresponding to a location on a surface of Earth that includes individual points mapped to a mathematical sphere.

22. The computer-implemented method of claim 20, wherein generating the identifier further comprises generating the identifier based at least in part on the physical boundary of the structure, the value that identifies the geographic cell derived based on the spherical projection, and a sequence number.

23. The computer-implemented method of claim 19, wherein the first input comprises one of an address, a name of an owner, a geocode, geographic coordinates, an assessor parcel number, or a second identifier.
